(19) United States
(12) Patent Application Publication
(10) Pub. No.: US 2013/0174644 A1
(43) Pub. Date: Jul. 11, 2013

(54) Test method for a humidity sensor and sensor module for same

(71) Applicants: Norbert Schneider, Tiefenbronn (DE); Alex Grossmann, Leonberg (DE); Uwe Konzelmann, Asperg (DE); Joerg Brueckner, Sindelfingen (DE); Wolfgang Dressler, Vaihingen/Enz (DE); Stefan Motz, Modugno (DE); Thilo Gleisberg, Saint-Cyr/Loire (FR); Christian Wolf, Ludwigsburg (DE)

(72) Inventors: Norbert Schneider, Tiefenbronn (DE); Alex Grossmann, Leonberg (DE); Uwe Konzelmann, Asperg (DE); Joerg Brueckner, Sindelfingen (DE); Wolfgang Dressler, Vaihingen/Enz (DE); Stefan Motz, Modugno (DE); Thilo Gleisberg, Saint-Cyr/Loire (FR); Christian Wolf, Ludwigsburg (DE)

(21) Appl. No.: 13/805,202

(22) PCT Filed: May 19, 2011
(86) PCT No.: PCT/EP2011/058118

§ 371 Date: Mar. 1, 2013

(30) Foreign Application Priority Data
Jun. 22, 2010 (DE) 102010030338.0

(51) Int. Cl. G01N 25/56

(52) U.S. Cl. CPC G01N 25/56
USPC 73/29.02

(57) ABSTRACT

A method for operating a sensor module having a humidity sensor for ascertaining the relative humidity, at least one first measured value for the relative humidity being ascertained with the aid of the humidity sensor. It is provided that an ambient temperature in the area of the humidity sensor is changed with the aid of a temperature control device; at least one second measured value for the relative humidity is ascertained with the aid of the humidity sensor after the change in ambient temperature in the area of the humidity sensor; and an operating state and/or a proper operation of the humidity sensor is inferred as a function of the first and second measured values.

### FIELD OF THE INVENTION

The present invention relates to a method for operating a sensor module having a humidity sensor for ascertaining the relative humidity, at least one measured value for the relative humidity being ascertained with the aid of the humidity sensor. The present invention also relates to a corresponding sensor module.

### BACKGROUND INFORMATION

It is understood that there are methods for operating a sensor module having a humidity sensor for ascertaining the relative humidity.

### SUMMARY OF THE INVENTION

An object of the exemplary embodiments and/or exemplary methods of the present invention is to improve upon a method and a sensor module of the type defined at the outset, in such a way that precise information about an operating state may be obtained.

In the method of the type defined at the outset, this object may be achieved according to the exemplary embodiments and/or exemplary methods of the present invention by the fact that an ambient temperature in the area of the humidity sensor is changed by a temperature control device. After changing the ambient temperature in the area of the humidity sensor, at least one second measured value for the relative humidity is ascertained with the aid of the humidity sensor and an operating state and/or a proper operation of the humidity sensor is/are inferred as a function of the first and second measured values.

The principle according to the exemplary embodiments and/or exemplary methods of the present invention is based on a targeted “offsetting” of an essential operating condition of the humidity sensor, namely the ambient temperature. According to investigations by the present patent applicant, the relative humidity also changes with the ambient temperature in the area of the humidity sensor according to thermodynamic principles with which those skilled in the art are familiar. It is thus advantageously possible to check on whether the humidity sensor in fact also indicates a change in the relative humidity corresponding to the change in temperature on the basis of the measured values for the relative humidity before and after the change in the ambient temperature, these measured values having been ascertained within the scope of the method according to the present invention.

According to one specific embodiment in particular, a fault in the humidity sensor may be inferred when the first and the second measured values for the relative humidity do not differ by at least one predefinable differential value, which may be selected as a function of the change in temperature.

According to another specific embodiment, the ambient temperature in the area of the humidity sensor may be increased by the temperature control device, in particular before the second measured value is ascertained. This requires a particularly low structural complexity for the implementation of the temperature control device, for example, in the form of an electrical resistance heating. Alternatively or in addition, the temperature control device may also reduce the ambient temperature in the area of the humidity sensor in the case of a suitable design, for example, with the aid of a Peltier element. It is also conceivable to carry out the method according to the present invention multiple times with changes in temperature in both directions. In the present case, a change in the ambient temperature in the area of the humidity sensor is understood to refer in particular to the change in the temperature of a medium such as air surrounding the humidity sensor.

In another particularly advantageous specific embodiment of the present invention in which the sensor module has an air flow sensor, it may advantageously be provided that a heating element of the air flow sensor is used as a temperature control device for changing the ambient temperature in the area of the humidity sensor. This necessitates a structural arrangement of the heating element and the humidity sensor in relation to one another, in such a way that the ambient temperature of the humidity sensor may be influenced with the aid of the heating element in a targeted manner. If the air flow sensor or also its heating element may be controlled separately from the remaining sensor module or the humidity sensor and may be supplied with electrical power, then it may advantageously be provided that the air flow sensor or its heating element is optionally activated and/or deactivated to change the ambient temperature in the area of the humidity sensor.

For example, air flow sensors configured as hot-film air flow sensors usually have a heating device configured to heat other components of the air flow sensor in a manner that is known per se. Thus, a change in the temperature, namely cooling in the surroundings of the humidity sensor, may be achieved advantageously by deactivating the hot-film air flow sensor within the scope of the method according to the present invention, thereby enabling a check on the function of the humidity sensor by a comparison of different measured values for the relative humidity at different temperatures.

Another approach to the object of the exemplary embodiments and/or exemplary methods of the present invention is given by a method as described herein. In this method, a temperature and an atmospheric pressure are ascertained in the area of the humidity sensor in addition to a measured value for the relative humidity. As a function of the temperature and the atmospheric pressure, at least one limiting value for the absolute water content of the air is ascertained in the area of the humidity sensor which cannot be exceeded on the basis of thermodynamic laws. Ascertaining an upper and a lower limiting value for the absolute water content of the air in the area of the humidity sensor is also conceivable. According to the present invention, an operating state and/or a proper operation of the humidity sensor may in turn be inferred as a function of the measured values for the relative humidity and the limiting value(s) for the absolute water content of the air. For example, if a relative humidity output by the humidity sensor is not consistent with the theoretical limiting value of the absolute water content ascertained from the temperature and the atmospheric pressure according to the present invention, then it is advantageously possible to infer a defect in the humidity sensor or the additional sensors involved (atmospheric pressure, temperature).

A sensor module as described herein is given as an additional approach to the object of the present invention.

Additional advantageous embodiments are the subject matter of the further descriptions herein.

Additional advantages, features and details are derived from the following description, in which various exemplary embodiments of the present invention are described with reference to the drawings. The features described herein and in the description may be essential to the present invention either individually or in any combination.

### BRIEF DESCRIPTIONS OF THE DRAWINGS

FIG. 1 schematically shows a simplified block diagram of a first specific embodiment of a sensor module having a humidity sensor.

FIG. 2 shows a simplified flow chart of one specific embodiment of an operating method for a humidity sensor according to FIG. 1.

FIG. 3 schematically shows a simplified block diagram of another specific embodiment of a sensor module.

FIG. 4 shows a simplified flow chart of one specific embodiment of an operating method for the sensor module according to FIG. 3.

### DETAILED DESCRIPTION

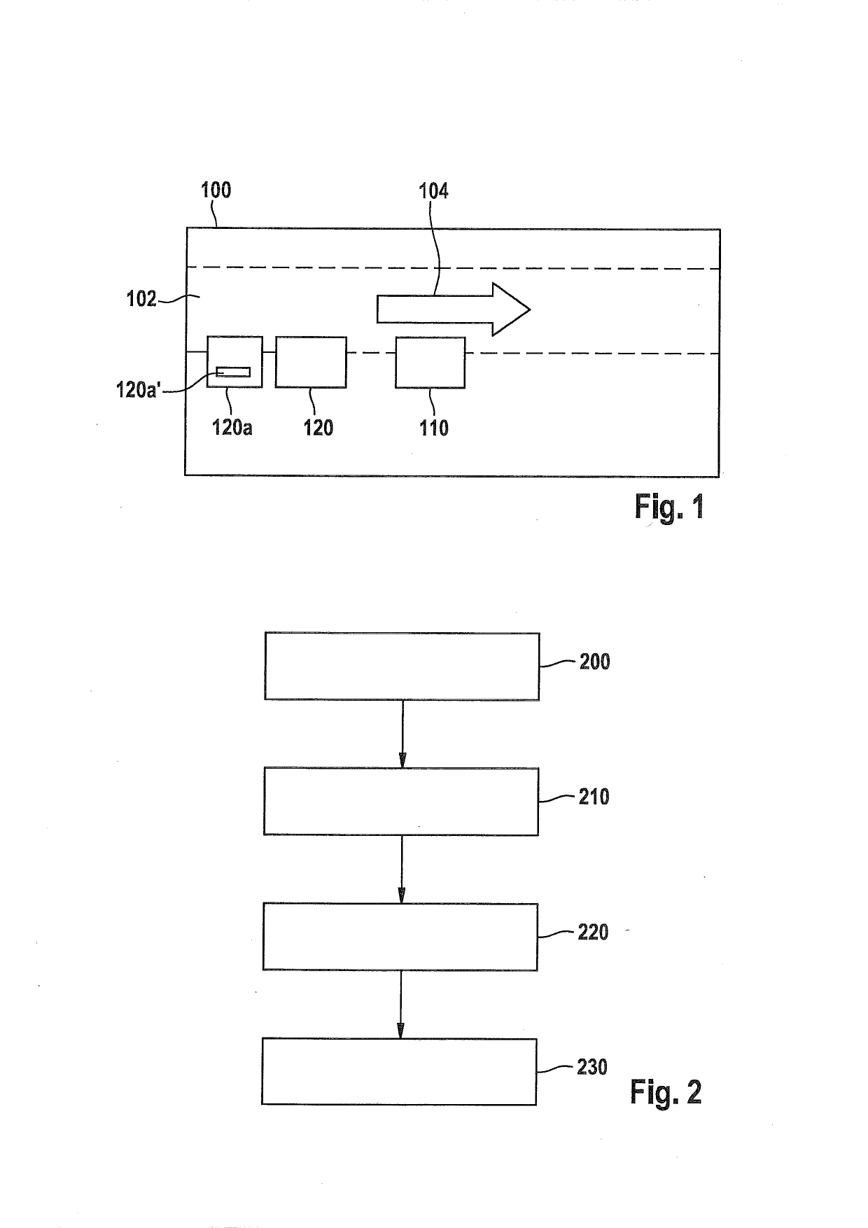

FIG. 1 schematically shows a sensor module 100 such as that used in the automotive field, for example, for ascertaining a relative humidity. Sensor module 100 has a measuring channel 102 through which a gaseous medium 104 passes for the purpose of the humidity measurement.

A humidity sensor 110 is situated in the area of measuring channel 102, as seen in FIG. 1, and is configured to detect the relative humidity of medium 104 passing through measuring channel 102.

Sensor module 100 has a temperature control device 120 in addition to humidity sensor 110, the temperature control device being configured to change an ambient temperature in the area of humidity sensor 110, for example, to reduce it and/or to increase it. Temperature control device 120 may heat or cool the medium to be measured (air 104) accordingly.

FIG. 2 shows a simplified flow chart of one specific embodiment of an operating method for sensor module 100. In a first step 200, at least one first measured value for the relative humidity of air 104 (FIG. 1) is ascertained with the aid of humidity sensor 110. In a subsequent step 210, the ambient temperature in the area of humidity sensor 110 is changed, for example increased, with the aid of temperature control device 120. Due to the increase in ambient temperature, gaseous medium 104 in the area of humidity sensor 110 may in principle contain a larger quantity of water vapor, but the absolute water content of medium 104 in measuring channel 102 and in particular in the area of humidity sensor 110 does not change due to the heating by temperature device 120. As a result, the relative humidity is lowered in accordance with the laws of thermodynamics.

In a third step 220 (FIG. 2), at least one second measured value for the relative humidity is ascertained with the aid of humidity sensor 110. In subsequent step 230, the first and second measured values for the relative humidity are analyzed with the goal of inferring an operating state and a proper operation or a fault in humidity sensor 110.

Analysis 230 may involve, for example, forming a difference between the two measured values for the humidity, and a fault in humidity sensor 110 may be inferred if the first and second measured values for the relative humidity do not differ by at least one predefinable difference. In other words, in this case humidity sensor 110 would have signaled a change in the relative humidity which does not correspond to the change in temperature despite a change 210 according to the present invention in the ambient temperature in the area of humidity sensor 110. The predefinable difference may be selected as a function of the change in temperature.

If the difference between the two measured values for the relative humidity, which is considered in step 230, corresponds sufficiently well to the change in the ambient temperature caused by temperature control device 120 according to the present invention, taking into account the applicable thermodynamic relationships, then it is inferred that humidity sensor 110 is operating properly.

In another particularly advantageous specific embodiment, sensor module 100 not only has humidity sensor 110 but also has an air flow sensor 120a (cf. FIG. 1). In the case of air flow sensors configured as hot-film air flow sensors in particular, air flow sensor 120a has an integrated heating element 120a′. According to another aspect of the present invention, heating element 120a′ of air flow sensor 120a may advantageously be used to induce a change in the ambient temperature in the area of humidity sensor 110. This may be accomplished, for example, by targeted activation or deactivation of air flow sensor 120a or its heating element 120a′.

In a corresponding embodiment of air flow sensor 120a, it is thus advantageously possible to omit the provision of a separate temperature control device 120 in sensor module 100.

If sensor module 100 according to FIG. 1 has a hot-film air flow sensor 120a as described in conjunction with FIG. 1, then sensor module 100 may be operated in a normal mode in which the humidity is ascertained with the aid of humidity sensor 110 and the air flow rate is ascertained with the aid of air flow sensor 120a. No diagnosis of sensor module 100 or its humidity sensor 110 takes place in this normal mode. To carry out a diagnosis of humidity sensor 110 using the principle according to the present invention, however, an activated air flow sensor 120a or its heating element 120a′ may be deactivated for a diagnostic procedure according to the present invention during normal mode, resulting in a reduction in the ambient temperature in the area of humidity sensor 110. During this reduction in ambient temperature, a second measured value for the relative humidity is ascertained by humidity sensor 110 in accordance with the method described above with reference to FIG. 2. This second measured value is analyzed together with measured values for the relative humidity ascertained previously, i.e., when air flow sensor 120 was activated and the ambient temperature of humidity sensor 110 was elevated accordingly (cf. step 230).

If a temperature control device 120 is provided which may raise or lower the ambient temperature and which is optionally present in sensor module 100, then the method according to the present invention may advantageously also be applied in a wider ambient temperature range, thus permitting a more detailed diagnosis of a working range of humidity sensor 110.

To monitor or regulate temperature control operation 210, sensor module 100 may also have a temperature sensor and a corresponding electronic control unit (not shown).

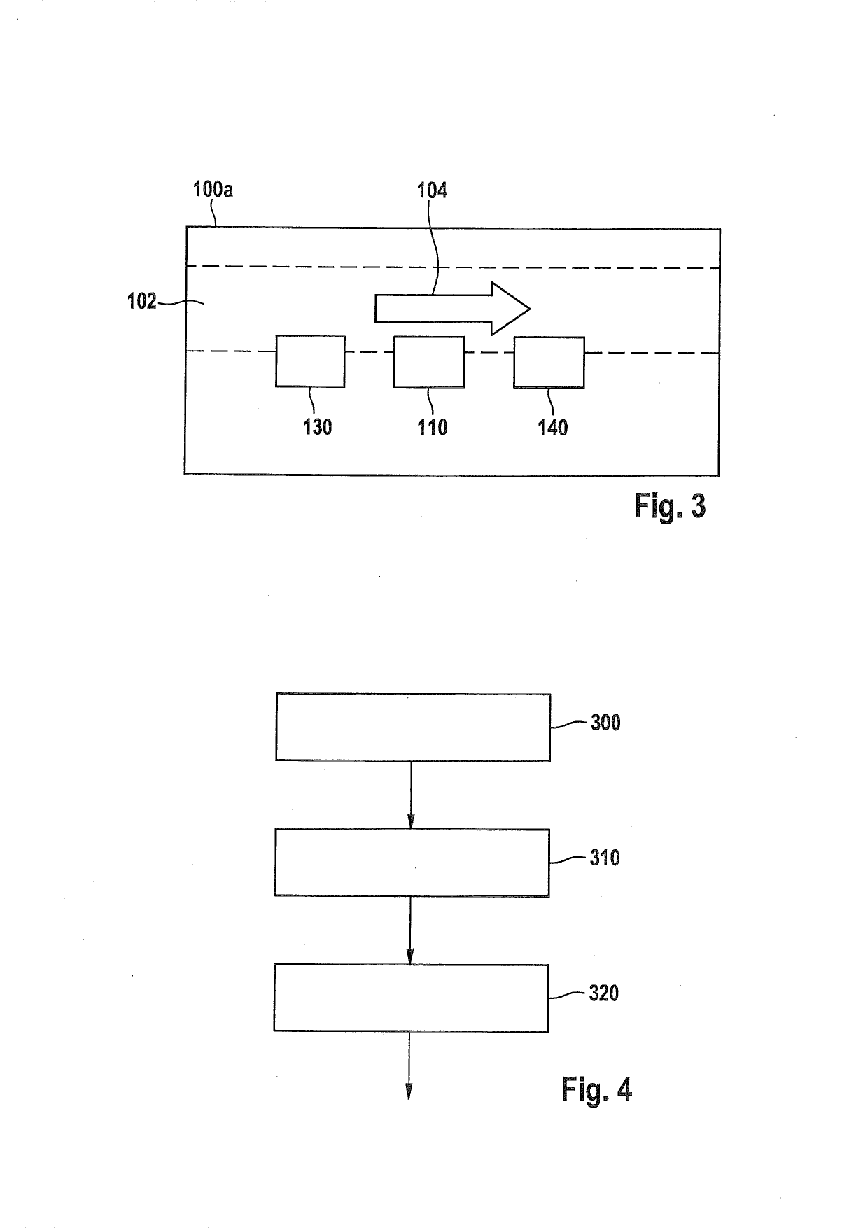

FIG. 3 shows another advantageous specific embodiment of a sensor module 100a having a humidity sensor 110 for ascertaining the relative humidity of a gaseous medium 104 passing through measuring channel 102.

The sensor module also has an air pressure sensor 130 for ascertaining an air pressure in measuring channel 102 and a temperature sensor 140 for ascertaining a temperature of a medium 104 passing through measuring channel 102.

In the case of sensor module 100a according to FIG. 3, the diagnostic procedure described below with reference to the flow chart according to FIG. 4 may be carried out.

In a first step 300, a measured value for the relative humidity is ascertained with the aid of humidity sensor 110. At the same time, the air pressure is ascertained with the aid of air pressure sensor 130 and the temperature of ambient air 104 in measuring channel 102 is ascertained with the aid of temperature sensor 140. In subsequent step 310, using known thermodynamic relationships, at least one limiting value for the absolute water content of gaseous medium 104 in the area of humidity sensor 110 is ascertained, for example, with the aid of a characteristics map. An upper and a lower limiting value for the absolute water content of gaseous medium 104 may also be ascertained. The limiting value may also be ascertained, for example, using a characteristics map or the like.

In step 320, an operating state and/or a proper operation of or a fault in humidity sensor 110 is/are inferred as a function of the measured value for the relative humidity and of the limiting value for the absolute water content of air 104. If the value for the relative humidity supplied by humidity sensor 110 is in conflict with the absolute water content, which is ascertained in step 310 and which depends on the temperature and atmospheric pressure prevailing in measurement channel 102, then it is possible to infer an error in at least one of components 110, 130, 140 involved.

The diagnostic principles described above with reference to FIGS. 1 and 3 may also be advantageously combined with one another. To do so, sensor module 100a according to FIG. 3 may be supplemented by adding a temperature control device 120 (FIG. 1), for example, or by adding an air flow sensor 120a, which implements the functionality of a temperature control device 120.

1-9. (canceled)

10. A method for operating a sensor module, having a humidity sensor for ascertaining the relative humidity, the method comprising:
determining at least one measured value for the relative humidity with the humidity sensor, wherein an ambient temperature in the area of the humidity sensor is changed with a temperature control device;
determining at least one second measured value for the relative humidity with the humidity sensor after the change in the ambient temperature in the area of the humidity sensor; and
inferring at least one of an operating state and a proper operation of the humidity sensor as a function of the first and second measured values.

11. The method of claim 10, wherein a fault in the humidity sensor (110) is inferred when the first and second measured values for the relative humidity do not differ by at least one predefinable differential value.

12. The method of claim 10, wherein the ambient temperature in the area of the humidity sensor is increased by the temperature control device before the second measured value is determined.

13. The method of claim 10, wherein the sensor module has an air flow sensor, and wherein a heating element of the air flow sensor is used as the temperature control device to change the ambient temperature in the area of the humidity sensor.

14. The method of claim 13, wherein the air flow sensor or its heating element is at least one of activated and deactivated to change the ambient temperature in the area of the humidity sensor.

15. The method of claim 10, wherein the sensor module has a humidity sensor for ascertaining the relative humidity, further comprising:
determining at least one measured value for the relative humidity with the humidity sensor;
determining a temperature and an atmospheric pressure in the area of the humidity sensor in addition to the measured value for the relative humidity;
determining at least one limiting value for the absolute water content of the air in the area of the humidity sensor as a function of the temperature and the atmospheric pressure; and
inferring at least one of an operating state and a proper operation of the humidity sensor as a function of the measured value for the relative humidity and the limiting value for the absolute water content.

16. A sensor module, comprising:
a sensor module arrangement, including:
a humidity sensor for ascertaining the relative humidity, wherein the sensor module arrangement is configured to determine at least one first measured value for the relative humidity with the humidity sensor, to change an ambient temperature in the area of the humidity sensor with a temperature control device, to ascertain at least one second measured value for the relative humidity with the humidity sensor after the change in the ambient temperature in the area of the humidity sensor, and to infer at least one of an operating state and a proper operation of the humidity sensor as a function of the first and second measured values.

17. The sensor module of claim 16, further comprising:
an air flow sensor, wherein a heating element of the air flow sensor is usable as a temperature control device for changing the ambient temperature in the area of the humidity sensor.

18. The sensor module of claim 16, wherein in addition to a measured value for the relative humidity, a temperature and an atmospheric pressure in the area of the humidity sensor determinable, and wherein the sensor module is configured to determine at least one limiting value for the absolute water content of the air in the area of the humidity sensor as a function of the temperature and the atmospheric pressure, and to infer at least one of an operating state and a proper operation of the humidity sensor as a function of the measured value for the relative humidity and of the limiting value for the absolute water content.
